(19) United States
(12) Patent Application Publication
(10) Pub. No.: US 2005/0001100 A1
(43) Pub. Date: Jan. 6, 2005

(54) Reinforced foam covering for cryogenic fuel tanks

(76) Inventors: Kuang Hsi-Wu, Miami, FL (US); Milton J. Torres, Miami, FL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/813,532

(22) Filed: Mar. 30, 2004

Related U.S. Application Data
(63) Continuation-in-part of application No. 09/665,257, filed on Sep. 19, 2000, now Pat. No. 6,722,611.

(51) Int. Cl. B64G 1/00

(52) U.S. Cl. 244/158 R

(57) ABSTRACT

A cryogenic fuel tank adapted for attachment to an aerospace vehicle includes an exterior layer of reinforced composite insulating foam. The insulating foam is reinforced with an aramid fiber mesh or a closed cell foam may be reinforced with one or more of carbon nanotubes, graphite whiskers, silicon carbide fibers or graphite fibers. The improved composite insulating structure disclosed herein provides a remedy for insulating material breaking off the large external fuel tank attached to the space shuttle during launch and ascent into space.

### RELATED APPLICATION DATA

The instant application is related to U.S. Provisional Patent Application Ser. No. 60/155,370, filed on Sep. 20, 1999, now abandoned and is a continuation-in-part of U.S. patent application Ser. No. 09/665,257, filed on Sep. 19, 2000, still pending.

### TECHNICAL FIELD

An improved cryogenic fuel storage tank for aerospace applications, including the space shuttle, is disclosed. The improved fuel tank is covered with a reinforced foam covering which resists breakage, rupture and general disintegration during launch and ascent of an aerospace vehicle, such as the space shuttle, before detachment of the fuel tank from the aerospace vehicle.

### BACKGROUND OF THE RELATED ART

The space shuttle external tank is the largest single component and the only major non-reusable component of the space shuttle system. Recent specifications indicate that the external tank is 154 feet long, 27.6 feet in diameter and carries more than 528,600 gallons (two million liters) of cryogenic propellants that are fed into the orbiters three main engines during the powered flight from ground to space.

The external tank is shown at 10 in FIG. 1 as attached to the space shuttle orbiter 11. Further, in FIG. 1, two rocket boosters 12, 13 are also shown.

Turning to FIG. 2, the external tank 10 includes three main components: the liquid oxygen tank portion 14 disposed in a forward position; the liquid hydrogen tank 15 disposed in an aft or rearward position; and an inner tank assembly 16 that connects the oxygen and hydrogen portions and houses the forward solid rocker booster attachment points, one of which is shown at 17. The orbiter 11 aft attachment mechanism is shown at 18.

The outer skin 19 of the external tank 10 is covered with a multi-layered thermal protective coating that is approximately one inch thick. The insulation allows the tank to withstand extreme internal and external temperatures generated during pre-launch, launch and ascent to space. The insulation (not shown in FIGS. 1 or 2) may vary in thickness and materials at different locations in the tank. However, generally, the insulation comprises sprayed-on foam insulation and pre-molded ablator materials. The insulation system may also include phenolic thermal insulators to preclude liquefaction. The insulation system is necessary, for example, for the liquid hydrogen tank portion 15 of the external tank 10 to prevent liquefaction of air-exposed metallic attachments and to reduce heat flow to the liquid hydrogen. Recent specifications indicate that the thermal protection system for the external tank 10 weighs about 4,800 pounds. The main component of the foam covering of the external tank 10 is polyisocyanurate (PIUR).

At liftoff, the external tank 10 absorbs approximately 7.8 million pounds of thrust load from the three main engines of the orbiter 11 and the two solid rocket boosters 12, 13. When the solid rocket boosters 12, 13 separate at an altitude of approximately 28 miles (45 kilometers), the orbiter 11, with the main engine still burning, carries the external tank 10 piggyback to near orbital velocity, approximately 70 miles (113 kilometers) above the earth. The now nearly empty tank 10 separates and falls in a pre-planned trajectory with a majority of the tank 10 disintegrating in the atmosphere and remaining debris falling into the ocean.

Since the Columbia tragedy of 2003, there has been widespread speculation and almost certain confirmation that a piece of the foam insulation dislodged from the external tank 10 and engaged and damaged the left wing of the orbiter 11, which led to the disintegration of the Columbia orbiter 11 upon re-entry. Seven astronauts were killed in the accident.

At least two different NASA reports and additional internal Lockheed Martin Corp. documents identified debris from the sprayed-on PIUR foam insulation as the greatest source of potential damage to the heat armor or tiles of the orbiter 11. According to these reports, almost every shuttle launch since 1981 has resulted in some foam debris breaking off of the external tank 10, thereby posing a potential safety hazard to the orbiter 11 upon reentry.

Accordingly, there is a dire need for an improved insulation system for the external tank 10 which can withstand the massive thrust load imposed thereon during launch and ascent to space. Improved foam insulation coatings for the external tank of the shuttle 10 would also be applicable to other aerospace vehicles utilizing cryogenic fuel tanks or fuel tanks requiring a robust insulation covering.

### SUMMARY OF THE DISCLOSURE

An improved cryogenic fuel tank is disclosed which includes an exterior surface having a skin layer. A composite insulation is affixed to the skin layer that includes a reinforcing material resulting in a composite insulating layer that has a compression strength and a tensile strength sufficient to prevent the composite insulating layer from fracturing or being separated from the fuel tank as a result of thrust imposed thereon during launch and ascent of a space vehicle.

Preferably, the insulating material is a closed cell foam, more preferably a closed cell PIUR foam. The reinforcing materials are also preferably selected from the group consisting of aramid fiber meshes, nanotubes, nanorods, fibers, graphite whiskers and silicon carbide whiskers. If discreet fibers such as nanotubes, nanorods or whiskers are utilized, they should preferably be of a size so that they can be accommodated within individual cells of the closed cell foam material.

The composite insulating materials disclosed herein may also be used on the interior of an aircraft, as a reinforcing and insulating material. Such aircraft may include orbiters as well as commercial and military aircraft.

### BRIEF DESCRIPTION OF THE DRAWINGS

FIG. 1 is a perspective view of a space shuttle orbiter, an external fuel tank and two solid booster rockets;

FIG. 2 is a perspective sectional view of the external tank shown in FIG. 1;

FIG. 3 is a schematic front view of a mesh grid reinforcing material constructed in accordance with one disclosed embodiment;

FIG. 4 is a schematic front view of an alternative reinforcing material constructed in accordance with another disclosed embodiment;

FIG. 5 is a sectional view of a foam layer reinforced with a reinforcing material as shown in FIGS. 3 and 4 and alternatively, discreet fiber elements or nanotubes interspersed therein in accordance with another disclosed embodiment;

FIG. 6 is a schematic plan view of a layer of PIUR foam reinforced with a fiber mesh illustrating both strong and weak link areas for the purpose of illustrating the improved properties of reinforced PIUR foam;

FIG. 7 graphically illustrates the improved material properties of PIUR foam reinforced with an aramid fiber mesh versus identical foams without a reinforcing mesh at varying temperatures;

FIG. 8 is an enlarged sectional view of a closed cell foam layer reinforced with carbon graphite fibers or other types of reinforcing fibers;

FIG. 9 is an enlarged sectional view of a closed foam layer reinforced with graphite whiskers or other types of reinforcing whiskers;

FIG. 10 graphically illustrates the improved fracture stress properties of graphite whisker reinforced closed cell PIUR foam versus unreinforced closed cell PIUR foam;

FIG. 11 graphically illustrates the improved compression stress properties of graphite whisker reinforced closed cell PIUR foam versus unreinforced closed cell PIUR foam;

FIG. 12 is an enlarged partial view of a carbon nanotube;

FIG. 13 is an enlarged sectional view of a layer of a closed cell PIUR foam reinforced with carbon nanotubes;

FIG. 14 schematically illustrates the fusing of carbon nanotubes fused together; and

FIG. 15 is a partial sectional view of an orbiter body with a skin layer, heat shield layer and reinforced foam layer in accordance with this disclosure.

### DETAILED DESCRIPTION OF THE PRESENTLY PREFERRED EMBODIMENTS

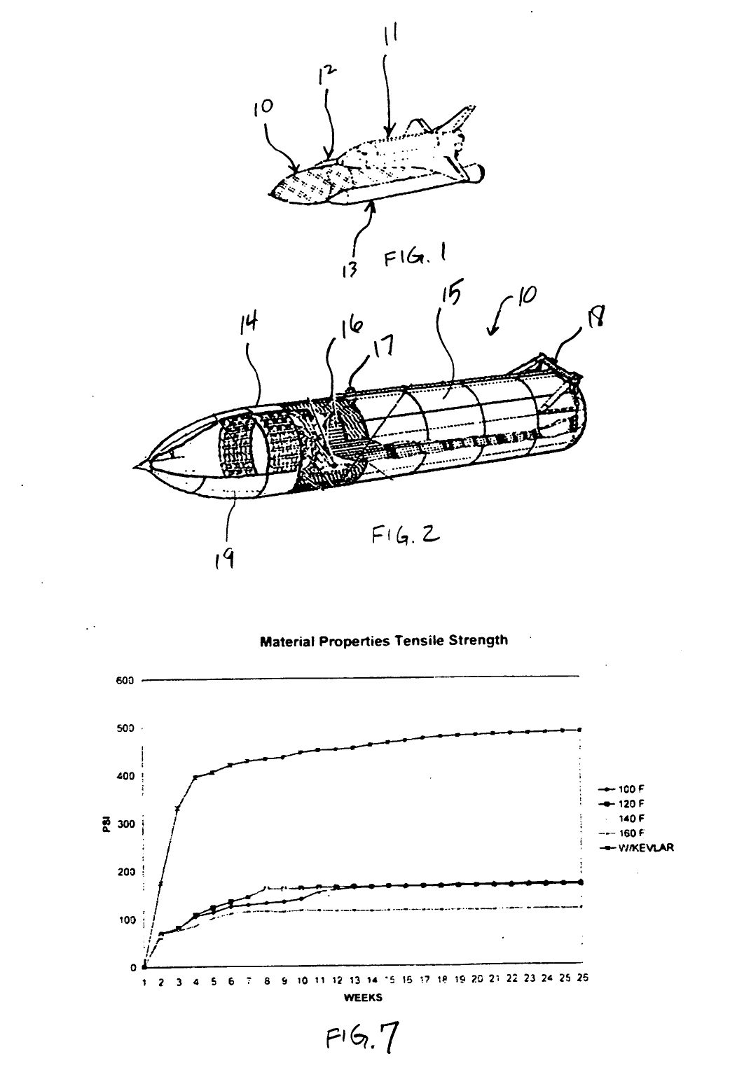

As noted above, PIUR foam has been used as the primary insulator for the space shuttle external fuel tank 10 which is shown in FIG. 2. PIUR foam offer relatively good compressive and tensile strength and further has a relatively low density, non-flammability and adheres well to the external skin 19 of the tank 10. Furthermore, PIUR foam is insoluble in most materials used to operate aircraft and aerospace vehicles, such as cleaning agents, hydraulic oils, lubricants and hydrocarbon fuels.

For purposes of this disclosure, a preferred embodiment is a closed cell PIUR foam for reasons that will be discussed below.

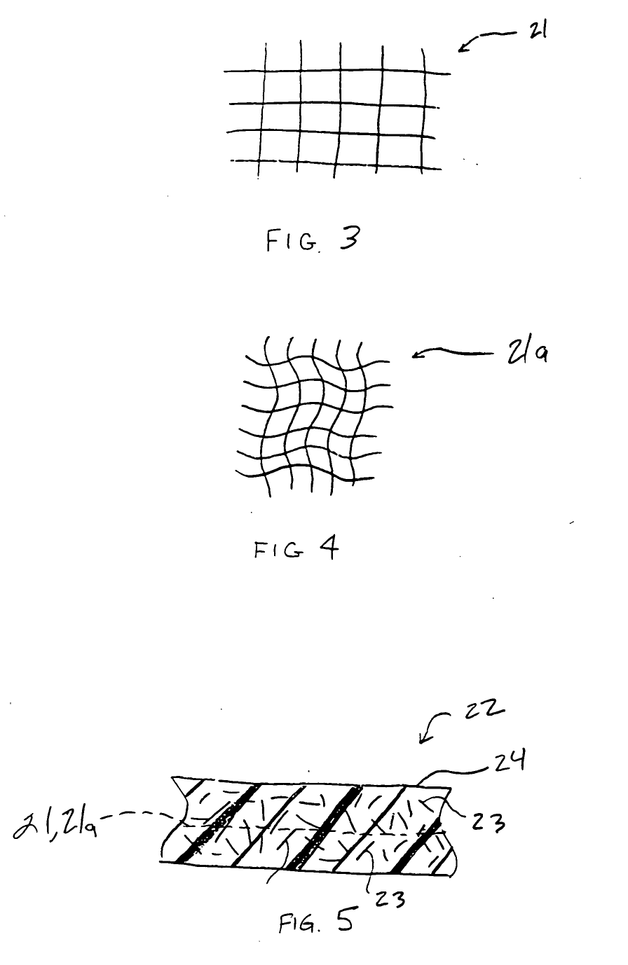

One improved reinforcing material comprises a grid 21 as shown in FIG. 3. The grid or mesh pattern 21 shown in FIG. 3 preferably comprises inter-connected fibers formed from an arimid fiber material. One such material is poly(p-phenylene terephthalamide), marketed by DuPont Corporation under the trade name KEVLAR and by Akzo Corporation under the trade name TWARON. A single layer, double layers or multiple mesh layers of the reinforcing mesh 21 can be added to the PIUR foam to reinforce the foam and form a composite layer of reinforced foam. Each mesh layer 21 can also be virtually any type of grid or mesh formation and the multiple layers can be oriented in the mesh or grid formations in many different arrangements relative to one another. For example, the grid 21 can simply be a grid of equally spaced horizontal and vertical cris-crossing fiber strands as shown in FIG. 3. Alternatively, a reinforcing grid 21a can include a plurality of equally spaced curvilinear cris-crossing fiber strands as shown in FIG. 4. The grid patterns can also be formed of randomly arranged and spaced fiber strands. The grid can also be a thin, tightly woven layer of fine fiber strands, almost a fabric, or can be formed of more spaced apart fibers. The disclosed embodiments are not limited by any particular type or pattern of mesh reinforcing layer or any particular type of fiber material.

FIG. 5 is a sectional view of a composite layer 22 of foam 24 that has been reinforced with one or two different reinforcing materials. Specifically, in FIG. 5, a reinforcing grid is shown in phantom at 21. Alternatively, the foam 24 can be reinforced with a plurality of loose fiber strands, continuous or discontinuous fibers, material particles, slivers, whiskers or nanotubes, for example, shown at 23 in FIG. 5 that are embedded or interspersed in the layer of foam material 24 as shown in FIG. 5.

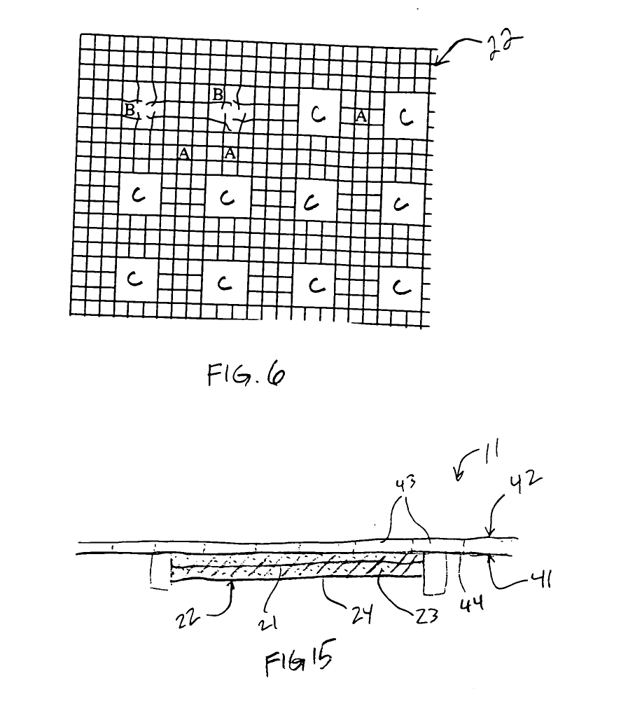

PIUR foam is an excellent insulator but is a relatively low-strength material. Test data indicates that the yield strength of PIUR foam is approximately 35 psi and its ultimate strength is in the order of 100-180 psi. By adding a single layer of KEVLAR mesh, an increase in ultimate strength of three-four fold was observed as shown in FIG. 7. Specifically, in FIG. 7, PIUR foam was sprayed into an aluminum mold where bone-shaped tensile specimens were cast. Unreinfoced specimens were tested over an extended period of time at temperatures ranging from 100° F. to 160° F. An additional specimen of PIUR foam reinforced with a KEVLAR mesh was also tested at the 100-160° F. range which exhibited an increase in ultimate strength of 3-4 times that of the unreinforced samples as shown in FIG. 7. Thus, for the external tank 10 of a space shuttle orbiter 11, KEVLAR mesh could be wrapped around the tank in between each spray process thereby eliminating the peeling and cracking of the foam during the launch and ascent.

The composite insulating layer can be formed and applied to the skin of the tank 10 in any suitable manner, although only some possible examples are disclosed herein. The foam material 24 can be poured or sprayed onto the tank 10, a layer of the reinforcing material 21, 21a, can be placed on the foam material 24, and then more foam material 24 can be poured or sprayed over the grid 21, 21a and first poured foam material 24. If more than one layer of reinforcing material 21, 21a is used, the sequence of pouring or spraying the foam material 24, placing the reinforcing material 21, 21a and subsequently pouring or spraying the foam material 24 can be repeated as needed.

Alternatively, the mesh 21, 21a of reinforcing material can be temporarily suspended against or near the exterior surface 19 of the tank 10. The foam material 24 can be poured or sprayed over the tank 10 and the mesh 21, 12a material simultaneously. The foam material 24 can flow over and through the mesh 21, 21a embedding the mesh 21, 21a in the foam 24 when cured.

Another example is to make or mold the layers 22 and then install the layers on the tank 10 skin layer. The composite insulating layer 22 may first be formed by adding the mesh material to the resin while it is in a liquid state in a mold and allowing the resin to cure. Alternatively, the mesh 21, 21a can first be secured in a mold and then the resin can be added to the mold in a liquid state. In either method, the mesh 21, 21a is embedded in the cured foam 24.

The addition of the reinforcing material to the foam increases the Young's modulus and strength of the foam significantly with an almost negligible weight gain. It was observed that by adding one layer of KEVLAR mesh, both Young's modulus and strength of the foam increased three to four-fold. A ten-fold increase of Young's modulus and strength can be obtained using a double-layer of KEVLAR.

FIG. 6 schematically illustrates the effectiveness of reinforced PIUR foam or other close cell polymer foam or other polymer foam versus unreinforced foam. Specifically, the zones labeled A represent strong link areas whereby the foam is effectively strengthened by a mesh material, such as a Kevlar mesh. The zones labeled B represent an area where the reinforced foam 22 may be allowed to crack or burst if there are air pockets or moisture pockets disposed between the reinforced foam 22 and the metal skin 19 of the fuel tank 10. These weak links shown at B and C serve as “safety valves” and will minimize the possibility of the dislodgement of larger chunks of reinforced foam 22 from the external tank 10. Thus, the reinforced layer 22 will accommodate for smaller air pockets or moisture pockets between the layer 22 and the skin 19 of the tank and allow for small pieces of reinforced foam 22 to dislodge, thereby avoiding any dislodgement of large pieces which could damage the orbiter 11.

Alternatively, loose fibers, particles, nanotubes or other material elements 23 as shown in FIG. 5 will add structural rigidity to the foam 24 when the foam 24 is cured. The loose fibers, particles, or the like can be added having particular lengths, thicknesses and shapes and can be added in particular amounts in order to achieve desired weight and/or strength characteristics. Nanotubes can also be added to the composite layer 22 and could serve the purpose of strengthening the inner face bonding between the metal skin 19 and the foam layer 22. The reinforcing affect at the interface will prevent the delamination of the composite foam layer 22 from the skin 19. In the case where air pockets or moisture pockets exist at the interface between the reinforced foam layer 22 and the skin 19, the possibility of the rupture and dislodgement of large pieces of reinforced foam 22 from the metal skin 19 can be minimized.

The composite insulating layer 22 is not to be limited to the use of a reinforcing material 21, 21b, 23 formed from aramid fibers, such as poly(p-phehylene terephthalamide). Other reinforcing materials may be used as well, such as carbon graphite fibers, other types of fibers, carbon graphite whiskers, nanotubes and nanorods as discussed below in connection with Fibs. 8-14, other possible reinforcing materials include: ceramic fibers; poly(m-phenylene terephthalamide), which is marketed by DuPont under the trade name NOMEX; silicon nitride; silicon carbide; polyamides; polyaramids; gel spun polyethylene; polyarylates; and sulfur fibers [e.g., materials formed from poly(phenylene sulfide)].

The use of other reinforcing materials may yield different strength results as those observed for KEVLAR mesh. If loose fiber material 23 is uniformly distributed in the foam material 24, as shown in FIG. 5, the resulting composite foam material 22 may not have the same strength to weight ratio as a composite foam material constructed with KEVLAR mesh 21, 21a. However, distributing loose fiber material 23 in the foam material 24 to form the composite layer 22 may provide greater weight savings in comparison to using KEVLAR mesh 21, 21a. In applications where weight reduction is critical and achieving very high strength in the composite foam material is not, a composite foam 24 material having uniform fiber or whisker 23 distribution in the foam material 24 may be the best solution.

Another exemplary method of applying the composite layer 22 of the tank 10 is to simultaneously form the layer 22 and to apply the layer 22 to the skin 19 of the tank 10 (see FIG. 2). If the reinforcing material 23 includes whiskers, small fiber strands or nanotubes, the fibers, whiskers or nanotubes can be mixed with the liquid foam 24 material and the foam 24 and reinforcing materials 24 can be subsequently poured or sprayed together.

The foam material 24 cures in place and attaches itself to the skin 1a of the tank 10, such that the tank skin 19 and the foam material 24 act as a composite unit. PIUR foam, for example, expands by about thirty times and adheres very well to most metals, including aluminum which is used as the skin or shell 19 of the tank 10. The amount of stress required to delaminate PIUR foam from aluminum skin is greater than the stress necessary to delaminate the foam itself. Therefore, the foam 24 will delaminate from itself before it delaminates from the skin 19.

Referring to FIG. 8, most carbon graphite fibers and SiC fibers offer excellent strength, stiffness and performance. Such fibers are excellent reinforcing materials for solid polymer systems but, as explained below in FIG. 8 can be less effective in closed cell foam materials, such as the preferred closed cell PIUR foam. A major problem associated with carbon graphite fibers is that they are too large in diameter compared to the size of the closed cells in the PIUR foam. Specifically, most carbon graphite fibers have relatively large diameters, from about 8 to about 10 μm and a length of several inches, compared to the closed cell size of PIUR foams, which have a cell diameter of about 200 μm and a cell wall thickness of about 1 μm. The carbon graphite fibers 31 can penetrate through the cells 32 when embedded in the foam 24 as shown in FIG. 8. Every time a fiber 31 enters or leaves a cell 32 and engages a cell wall 33, the fiber 31 can create a stress point or stress concentration and, as a consequence, can lower the strength of the foam 24. The foam material between adjacent fibers is not reinforced. Therefore, this unreinforced foam material results in a weak link shown at B or C in FIG. 6. Failure of crack propagation may occur in these regions B, C. As a consequence, adding conventional carbon, SiC or graphite fibers may not be able to strengthen this portion of the foam layer. However, mixing of the much smaller fibers, nanotubes and whiskers as disclosed herein will provide a superior strengthening affect.

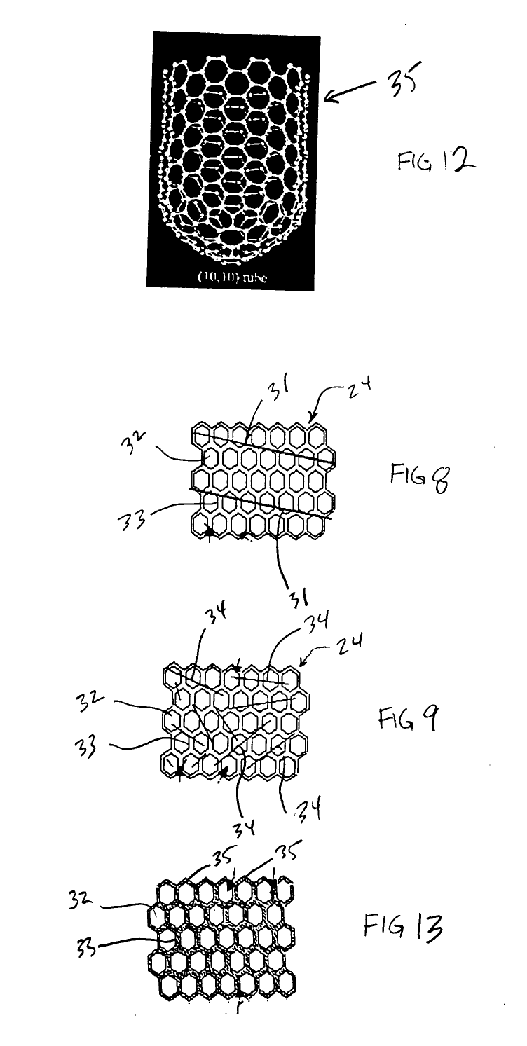

A similar occurrence can be experienced with graphite whiskers 34 as shown in FIG. 9. However, the problems associated with the use of carbon fibers 31 can be alleviated with graphite whiskers or silicon carbide whiskers or nanotubes 34 are used that have a diameter ranging from several nm to about 1 μm and a length ranging from about 5 to about 50 μm. While these dimensions may not be obtainable with readily available carbon graphite whiskers, but applicants have found that such dimensions are available using readily available SiC whiskers. As shown in FIGS. 10 and 11, the addition of about 10% volume fraction of SiC whiskers to a closed cell PIUR foam result in an approximately ten-fold increase in tensile strength (FIG. 10) and in an approximately ten-fold increase compressive strength (FIG. 11). Thus, the use of SiC whiskers is clearly an attractive alternative.

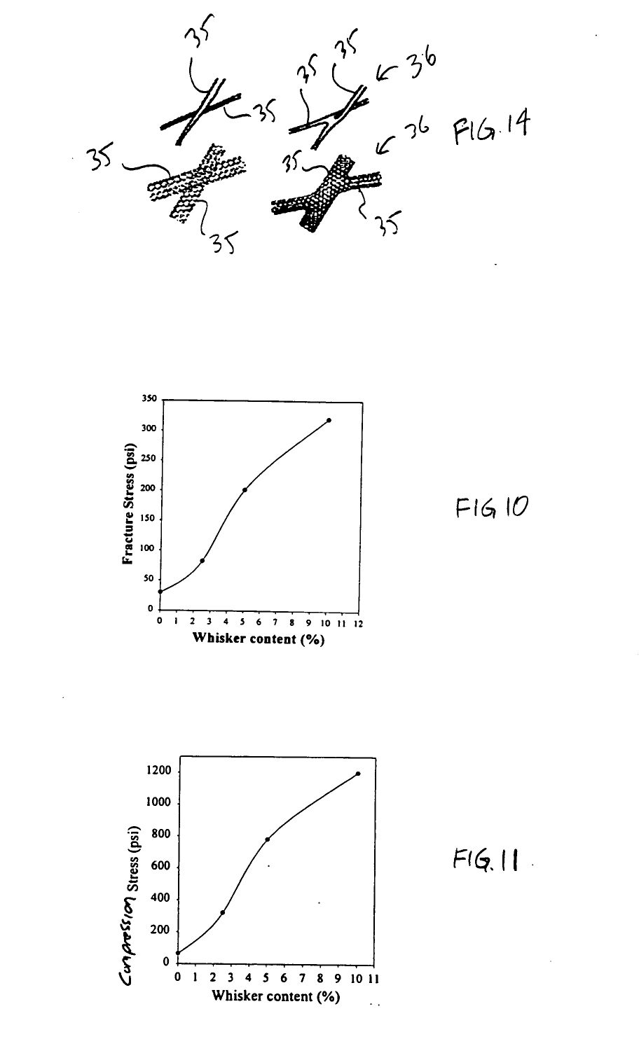

Still another preferred embodiment is the use of carbon nanotubes as shown in FIGS. 12 and 13. Carbon nanotubes (CNTs) have been available since 1991 and exhibit excellent stiffness, resilience and strength. In addition to e CNTs, other types of nanotubes and nanorods are available including, but not limited to nanotubes and nanorods made from Al₂O₃, BN and other various oxides. Such nanotubes and nanorods can have an elastic stiffness comparable to that of diamonds (1,000 GPa) but can be ten times strong than diamonds. Nanotubes and nanorods are approximately 100 times stronger than most steels and about ⅙ of the weight of most steels. Nanotubes and nanorods may have exceedingly small dimensions (1-20 nm in diameter). The small size of such nanotubes and nanorods 35 allows the nanotubes 35 to remain inside the closed cells 32 and against the cell walls 33 as shown in FIG. 13. Referring back to FIG. 12, nanotubes or nanorods 35 may be approximately 1 to 2 nm in diameter and range from about 0.1 to about 50 μm in length. The small dimensions allow the nanotubes or nanorods to stay within inside the cell walls 33 as shown in FIG. 13 without penetrating through the cell walls 33 thereby generating an optimal strengthening affect.

Data indicates that adding only 3% volume fraction of nanotubes or nanorods into all PIUR foam improves the compression strength of the foam by three to four times. However, as shown in FIG. 14, if the nanotubes or nanorods 35 can be fused together to form fused structures 36 to form a network structure, the fused structures 36 can greatly enhance the strength of PIUR close cell foams. Nanotubes or nanorods 35 can also be wrapped with polymer molecules on their surfaces to enhance their interface bonding with the PIUR foam thereby further increasing the strength of the reinforced PIUR foam.

Finally, FIG. 15 is an illustration of the orbiter body 11 with an aluminum skin layer 41 connected to a heat shield layer 42, that, in the case of the space shuttle orbiter 11 (FIG. 1), typically includes a plurality of ceramic tiles shown at 43. A reinforced foam layer 22 is attached to an inside surface 44 of the aluminum skin 41. The composite layer 24, as discussed above with respect to FIGS. 3-14, comprises foam material 24 reinforced with a mesh 21 and/or discreet fibers shown schematically at 23. Adding a PIUR reinforced composite to the interior of the shuttles aluminum fuselage 41 would also provide added safety protection for the shuttle and the astronauts because, as disclosed in co-pending application Ser. No. 09/665,257 and the earlier provisional application Ser. No. 60/155,370, the reinforced foam layers disclosed herein and in those two applications provides improved strength to aircraft and aerospace bodies.

Further, adding a PIUR-KEVLAR mesh composite layer 22 or a nanotube or nanorod reinforced layer 22 to the interior of the shuttle's aluminum fuselage would also provide additional fire or heat protection for the orbiter 11 and its astronauts. Burn tests demonstrate that it took 13 minutes to burn through a 0.004 in aluminum skin with a two inch foam layer attached to it using an acetylene torch with a temperature of about 5,000° F. The same aluminum skin without the PIUR foam adhered thereto burned through in only six seconds. Thus, the composite reinforced PIUR foam disclosed herein also provides improved protection for the orbiter 11 as well as the external tank 10.

The foregoing detailed description has been given for clearness of understanding only, and no necessary limitations should be understood therefrom, as modifications would be obvious to those skilled in the art.

1. A cryogenic fuel tank comprising:
an exterior surface comprising a skin layer; and
a composite insulation layer affixed to at least a substantial portion of the skin layer, the composite insulating layer including a reinforcing material combined with a non-flammable polymer foam material.

2. The fuel tank of claim 1 wherein the polymer foam material comprises a closed cell foam material.

3. The fuel tank of claim 1 wherein the the foam material is polyisocyanurate foam.

4. The fuel tank of claim 3 wherein the polyisocyanurate foam is a closed cell foam.

5. The fuel tank of claim 1 wherein the polymer foam material comprises polyurethane foam.

6. The fuel tank of claim 5 wherein the polyurethane foam is a closed cell foam.

7. The fuel tank of claim 1 wherein the reinforcing material includes at least one sheet of material added to the polymer foam material.

8. The fuel tank of claim 7 wherein the at least one sheet is a mesh grid sheet of fibers embedded within a layer of the polymer foam material.

9. The fuel tank of claim 8 wherein the at least one sheet is a mesh grid sheet of aramid fiber material.

10. The fuel tank of claim 9 wherein the at least one sheet is a mesh grid sheet having a plurality of interconnected linear fibers.

11. The fuel tank of claim 9 wherein the at least one sheet is a mesh grid having a plurality of interconnected curvilinear fibers.

12. The fuel tank of claim 1 wherein the reinforcing material is selected from the group consisting of nanotubes, nanorods, graphite whiskers, graphite epoxy, poly(p-phenylene terephthalamide) aramid fiber, carbon graphite fiber, poly(m-phenylene terephthalamide) fiber, silicone nitride fiber, silicone carbide fiber, polyaramid fiber, gel-spun polyethylene fiber, polyarylate fiber, and poly(phenylene sulfide) fiber.

13. The fuel tank of claim 1 wherein the reinforcing material comprises a plurality of discrete strengthening fibers interspersed and embedded within a layer of the polymer foam material.

14. The fuel tank of claim 13 wherein the discrete fibers are selected from the group consisting of silicon carbide fibers, nanotubes, nanorods, carbon graphite whiskers and carbon graphite fibers.

15. The fuel tank of claim 14 wherein the discrete fibers are nanotubes.

16. The fuel tank of claim 15 wherein the nanotubes have diameters ranging from about 1 to about 2 nm and lengths ranging from about 0.1 μm to about to about 50 μm.

17. The fuel tank of claim 16 wherein the polymer foam material is a closed cell foam having a cell size of about 200 μm.

18. The fuel tank of claim 16 wherein a plurality of the nanotubes intersect and are fused to one or more other nanotubes.

19. The fuel tank of claim 14 wherein the discrete fibers are carbon graphite whiskers having a diameter ranging from about 0.1 to about 1 μm and a length ranging from about 5 to about 50 μm.

20. The fuel tank of claim 19 wherein the polymer foam material is a closed cell foam having a cell size of about 200 μm.

21. The fuel tank of claim 14 wherein the discrete fibers are carbon fibers having diameters of less than 8 μm and the polymer foam material is a closed cell foam having a cell size of about 200 μm.

22. A cryogenic fuel tank for attachment to an exterior of an orbiter during launch and ascent, the fuel tank comprising:
a skin layer having an exterior surface; and
a composite insulation layer affixed to at least a substantial portion of the exterior surface of the skin layer, the composite insulating layer including a reinforcing material embedded with a closed cell polyisocyanurate foam, the reinforcing material being selected from the group consisting of nanotubes, nanorods, graphite whiskers, silicone carbide fiber, poly(p-phenylene terephthalamide) aramid fiber mesh, and poly(m-phenylene terephthalamide) fiber mesh.

23. The fuel tank of claim 22 wherein reinforcing material consists essentially of the discrete fibers are nanotubes having diameters ranging from about 1 to about 2 nm and lengths ranging from about 0.1 μm to about to about 50 μm and the polyisocyanurate foam is a closed cell foam having a cell size of about 200 μm.

24. The fuel tank of claim 23 wherein a plurality of the nanotubes intersect and are fused to one or more other nanotubes.

25. The fuel tank of claim 22 wherein reinforcing material consists essentially of the discrete fibers are carbon graphite whiskers having a diameter ranging from about 0.1 to about 1 μm and a length ranging from about 5 to about 50 μm and the polyisocyanurate foam is a closed cell foam having a cell size of about 200 μm.

26. The fuel tank of claim 22 wherein the reinforcing material consists essentially of poly(p-phenylene terephthalamide fiber mesh.

27. A method for strengthening an exterior insulation layer on an exterior surface of a skin of a cryogenic fuel tank, the method comprising:
providing a quantity of a non-flammable polymer foam material and a reinforcing material;
combining the polymer foam material and the reinforcing material to form a composite insulating layer; and
affixing the composite insulating layer in an uncured state to at least a substantial portion of the exterior surface of the skin.

28. The method of claim 27 wherein the combining further comprises:
embedding the reinforcing material in the foam material when the foam material is in a liquid state.

29. The method of claim 28 wherein the embedding further comprises:
spraying the exterior surface of the skin of the fuel tank with the foam material to form a first layer of foam material thereon;
placing at least one sheet of the reinforcing material over the first layer of foam material; and
spraying a second layer of foam material on the sheet and first layer.

30. The method of claim 28 wherein embedding further comprises:
adding a plurality of discrete strengthening fibers to the foam material before the foam material is cured and affixed to the exterior surface of the skin.

31. The method of claim 27 wherein the combining and affixing are completed substantially simultaneously.

32. The method of claim 28 further comprising:
adding a foam material layer in a liquid state onto the exterior surface of the skin;
placing a reinforcing material layer on the first foam material layer;
adding another foam material layer in a liquid state onto the first foam material and reinforcing material layers; and
curing the foam material layers.

33. The method of claim 32 wherein the adding further comprise pouring the liquid foam material.

34. The method of claim 32 wherein adding further comprise spraying the liquid foam material.

35. The method of claim 32 wherein the adding, placing and adding are repeated a desired number of times.

36. The method of claim 27 further comprising:
securing at least one reinforcing material layer adjacent the exterior surface of the skin;
adding a foam material layer in the liquid state in such a manner to substantially encapsulate the reinforcing material layer in the foam material layer; and
curing the foam material layer.

37. The method of claim 36 wherein the adding further comprises:
pouring the liquid foam material over the reinforcing material layer and the skin layer.

38. The method of claim 37 wherein the adding further comprises:
spraying the liquid foam layer over the reinforcing material layer and the skin layer.

39. The method of claim 27 wherein the combining further includes adding a sufficient amount of the reinforcing material to a sufficient amount of the polymer foam material so that the composite insulating layer has a compressive strength and a tensile strength sufficient to prevent the composite insulating layer from fracturing and being separated from the fuel tank as a result of thrust imposed on the composite insulating layer during a launch and ascent to space when the fuel tank is attached to a space shuttle orbiter.

40. The method of claim 27 wherein the polymer foam material comprises a closed cell polyisocyanurate foam.

41. The method of claim 40 wherein the reinforcing material is selected from the group consisting of nanotubes, nanorods, graphite whiskers, silicone carbide fiber, poly(p-phenylene terephthalamide) aramid fiber mesh, and poly(m-phenylene terephthalamide) fiber mesh.

42. The method claim 41 wherein the reinforcing material consists essentially of the discrete fibers are nanotubes having diameters ranging from about 1 to about 2 nm and lengths ranging from about 0.1 μm to about to about 50 μm and the polyisocyanurate foam is a closed cell foam having a cell size of about 200 μm.

43. The method claim 42 wherein a plurality of the nanotubes intersect and are fused to one or more other carbon nanotubes.

44. The method of claim 41 wherein the reinforcing material consists essentially of discrete fibers are carbon graphite whiskers having a diameter ranging from about 0.1 to about 1 μm and a length ranging from about 5 to about 50 μm and the polyisocyanurate foam is a closed cell foam having a cell size of about 200 μm.

45. A space orbiter comprising:
a skin layer comprising an interior surface; and
a composite insulation layer affixed to at least a substantial portion of the skin layer, the composite insulating layer including a reinforcing material combined with a closed cell polyisocyanurate foam,
the reinforcing material being selected from the group consisting of nanotubes, nanorods, graphite whiskers, silicone carbide fiber, poly(p-phenylene terephthalamide) aramid fiber mesh, and poly(m-phenylene terephthalamide) fiber mesh.
